(19) United States
(12) Patent Application Publication
(10) Pub. No.: US 2004/0150457 A1
(43) Pub. Date: Aug. 5, 2004

(54) Frequency mixing circuit

(76) Inventor: Hiroshi Miyagi, Niigita (JP)

Correspondence Address: DELLETT AND WALTERS, P. O. BOX 2786, PORTLAND, OR, 97208-2786, US

(21) Appl. No.: 10/481,996

(22) PCT Filed: Jun. 26, 2002
(86) PCT No.: PCT/JP02/06399

(30) Foreign Application Priority Data
Jun. 29, 2001 (JP) 2001-198216
Dec. 26, 2001 (JP) 2001-395234

(51) Int. Cl. G06G 7/12

(52) U.S. Cl. 327/355

(57) ABSTRACT

A frequency mixing circuit which can reduce frequency noises generated when integrally molded with a semiconductor substrate by using the CMOS process or the MOS process. A high-frequency amplifier circuit 11, a mixing circuit 12, a local oscillator 13, medium-frequency filters 14 and 16, a medium-frequency amplifier 15, a limit circuit 17, an FM detection circuit 18 and a stereo demodulation circuit 19 which constitute an FM receiver are formed in a one-chip component 10. The mixing circuit 12 is formed on a semiconductor substrate by using the CMOS process or the MOS process. A p-channel type FET is used to constitute the circuit.

### TECHNICAL FIELD

The present invention relates to a frequency mixing circuit used for frequency conversion of a receiver.

### BACKGROUND ART

A general receiver adopting a super-heterodyne method converts a frequency by using a frequency mixing circuit after amplifying a modulated wave signal received via an antenna at a high frequency, and demodulates it after converting it into an intermediate-frequency signal having a predetermined frequency.

Particularly, in recent years, a research is underway as to a technology for integrally forming an analog circuit including a frequency mixing circuit on a semiconductor substrate by using CMOS process or MOS process, which is put to practical use in certain apparatuses. It is possible, by forming various kinds of circuits on one chip by using the CMOS process or the MOS process, to miniaturize and reduce cost of the entire apparatus. Therefore, it is thinkable that the range of the apparatuses to be formed on one chip will expand from now on.

Incidentally, in the case of molding a frequency mixing circuit by using CMOS process or MOS process, there is a problem that low-frequency noise called 1/f noise increases depending on a frequency band to be used. In particular, a MOS-type FET has more 1/f noise than a bipolar transistor, and a large number of transistors are used for the frequency mixing circuit for the sake of mixing two types of signals so that each of them becomes a noise source and the noise generated by the entire circuit increases. If the 1/f noise generated by the frequency mixing circuit increases, it means that a ratio of the 1/f noise component in the medium-frequency signal becomes higher, resulting in deterioration of receiving quality due to decline in an SN ratio.

### DISCLOSURE OF THE INVENTION

The present invention was created in view of these points, and an object thereof is to provide a frequency mixing circuit capable of reducing low-frequency noise generated in the case of integrally molding it with a semiconductor substrate by using CMOS process or MOS process.

To solve the above-mentioned problem, the frequency mixing circuit according to the present invention has its components including transistors integrally formed on the semiconductor substrate by using the CMOS process or the MOS process, and these transistors are formed by using p-channel type FETs. The transistors included in the frequency mixing circuit are the p-channel type FETs of which mobility is low so that it is possible to reduce 1/f noise itself generated in the respective transistors so as to reduce the low-frequency noise generated in the entire frequency mixing circuit.

It is desirable that an N-well is formed on the above-mentioned semiconductor substrate, and the components are formed on the N-well. It is possible, by forming all the components of the frequency mixing circuit including the p-channel type FETs on the N-well, to have a pn joint surface formed between the N-well and the semiconductor substrate beneath it so as to prevent a noise current from running via the joint surface. Therefore, it is possible to prevent the noise generated in the frequency mixing circuit from sneaking on another component through the semiconductor substrate.

It is also desirable that the above-mentioned semiconductor substrate has a guard ring formed around the components thereon. Thus, it is possible to further effectively prevent the noise generated in the frequency mixing circuit from sneaking on another component through the semiconductor substrate.

It is also desirable that the guard ring is formed, around the above-mentioned components, down to a position deeper than the N-well from the semiconductor substrate's surface. It is possible, by forming the guard ring down to the deeper position than the N-well, to eliminate the low-frequency noise sneaking between the components formed on the N-well and external components beyond the guard ring.

### BEST MODE FOR CARRYING OUT THE INVENTION

Hereafter, a frequency mixing circuit (hereafter, merely referred to a “mixing circuit”) according to an embodiment of the present invention will be described in detail.

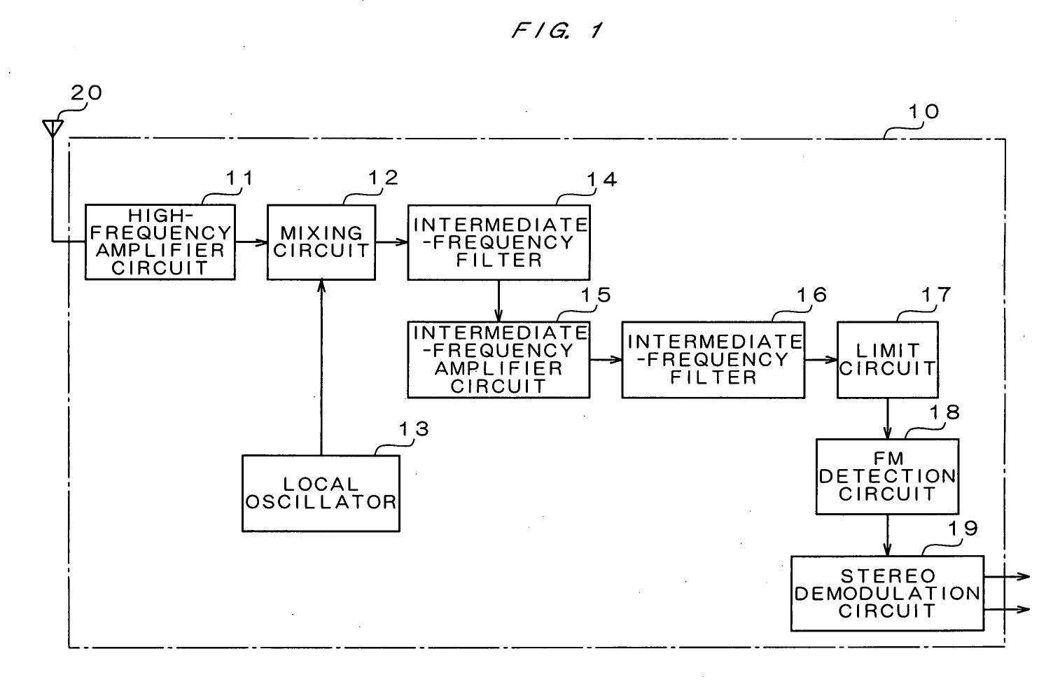

FIG. 1 is a diagram showing a configuration of an FM receiver including the mixing circuit of this embodiment. The FM receiver shown in FIG. 1 is comprised of a high-frequency amplifier circuit 11, a mixing circuit 12, a local oscillator 13, medium-frequency filters 14, 16, an medium-frequency amplifier circuit 15, a limit circuit 17, an FM detection circuit 18 and a stereo demodulation circuit 19 which are formed as a one-chip component 10.

After amplifying an FM modulated wave signal received by an antenna 20 with the high-frequency amplifier circuit 11, a high-frequency signal is converted into a medium-frequency signal by mixing it with a local oscillation signal outputted from the local oscillator 13. The medium-frequency filters 14 and 16 are provided to a preceding stage and a subsequent stage to the medium-frequency amplifier circuit 15, and extract only a predetermined band component from an inputted medium-frequency signal. The medium-frequency amplifier circuit 15 amplifies some medium-frequency signals passing through the medium-frequency filters 14 and 16.

The limit circuit 17 amplifies the inputted medium-frequency signal with a high gain. The FM detection circuit 18 performs FM detection to a signal of fixed amplitude outputted from the limit circuit 17. The stereo demodulation circuit 19 performs stereo demodulation to a composite signal after the FM detection outputted from the FM detection circuit 18 so as to generate an L signal and an R signal.

The above-mentioned one-chip component 10 of this embodiment is integrally formed on the semiconductor substrate by using CMOS process or MOS process. This semiconductor substrate has only the circuits constituting the one-chip component 10 shown in FIG. 1 formed thereon, or also has various analog and digital circuits molded thereon. It is easy to form various CMOS components by using the CMOS process or the MOS process. Therefore, it is desirable, for instance, to have a frequency synthesizer for varying an oscillation frequency of the local oscillator 13 to set a receiving frequency, a display and a control circuit thereof formed on the same semiconductor substrate.

Incidentally, the FET formed by using the CMOS process or the MOS process is generally characterized by having significant 1/f noise which is low-frequency noise compared to a bipolar transistor. Therefore, if the one-chip component 10 shown in FIG. 1 is formed on one chip by using the CMOS process or the MOS process, the FET as an amplification element included therein becomes a source of the 1/f noise. Furthermore, in the case of converting a modulated wave signal of a high frequency into an medium-frequency signal of a low frequency by using the mixing circuit 12, the ratio of the 1/f noise component in the medium-frequency signal becomes higher, resulting in deterioration of receiving quality due to decline in an SN ratio.

For this reason, the one-chip component 10 constituting the FM receiver according to this embodiment uses at least the p-channel type FETs as the amplification elements (transistors) included in the mixing circuit 12.

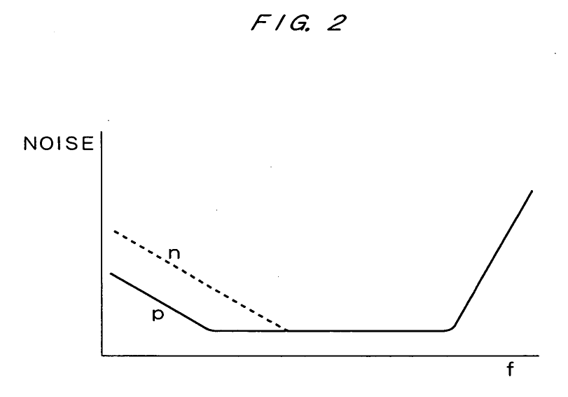

FIG. 2 is a diagram showing a noise characteristic of the FET manufactured by using the CMOS process or the MOS process. The horizontal axis indicates the frequency, and the vertical axis indicates the noise level respectively. The characteristic indicated in full line shows the noise characteristic of the p-channel type FET, and the characteristic indicated in dotted line shows the noise characteristic of the n-channel type FET respectively. As shown in FIG. 2, the p-channel type FET has less 1/f noise appearing in a low-frequency area than the n-channel type FET. It is supposedly because the p-channel type FET has less mobility.

Therefore, the 1/f noise itself generated by the FETs included in the mixing circuit 12 can be reduced by using the p-channel type FETs as the amplification elements. Thus, it is possible to reduce generation of the low-frequency noise in the mixing circuit 12 so as to improve the SN ratio and signal quality of the entire receiver.

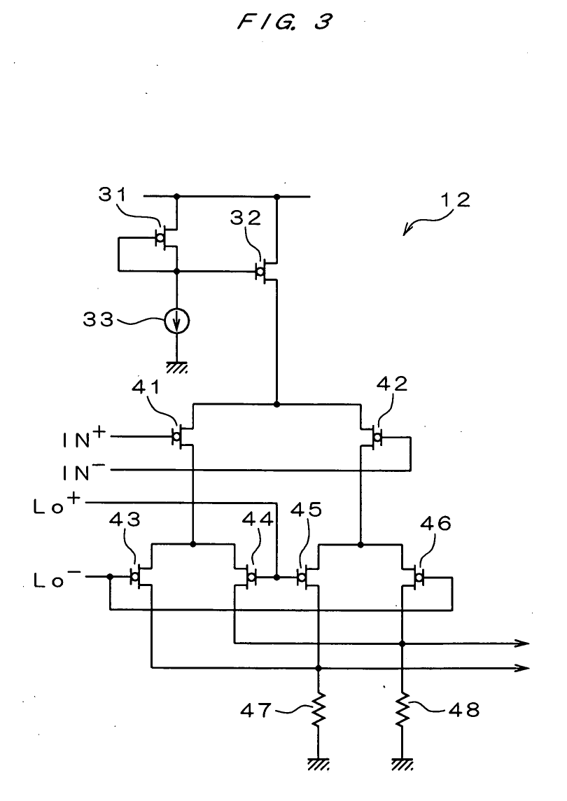

FIG. 3 is a circuit diagram showing a concrete configuration of the mixing circuit 12, which shows an example operated by a differential. The mixing circuit 12 shown in FIG. 3 is comprised of FETs 31, 32 and a current source 33 for generating constant currents, six FETs 41 to 46 for synthesizing two types of input signals, and two load resistances 47 and 48. To be more precise, the input signals (IN⁺, IN⁻) from the high-frequency amplifier circuit 11 are inputted to the FETs 41 and 42, and the input signals (Lo⁺, Lo⁻) from the local oscillator 13 are inputted to the FETs 43 to 46. The p-channel type FETs are used for all the FETs 31, 32 and 41 to 46 included in this configuration. It is also possible, by taking out output signals by using the load resistances 47 and 48, to form all the components constituting the above-mentioned mixing circuit 12 on the semiconductor substrate.

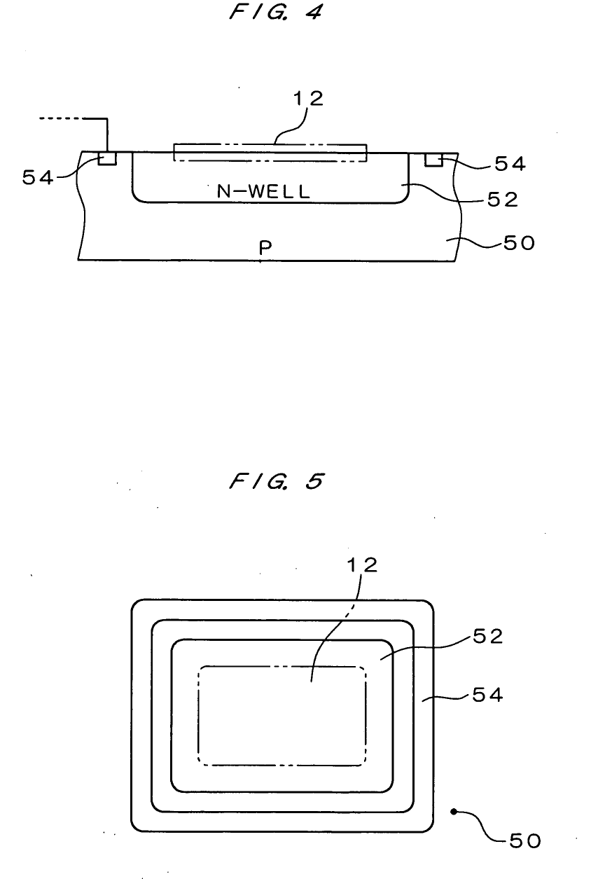

FIG. 4 is a sectional view showing a modified example of the mixing circuit 12 of the above-mentioned embodiment. FIG. 5 is a plan view of the configuration shown in FIG. 4. In the configuration shown in these drawings, all the components of the mixing circuit 12 are formed on an N-well 52. A PN joint surface is formed between the N-well 52 and a P-type semiconductor substrate 50. Therefore, in the case where an electrical potential of the N-well 52 is higher than that of the semiconductor substrate 50, the current running from the N-well 52 to the semiconductor substrate 50 is interrupted by the PN joint surface. For this reason, it is possible to prevent the noise generated in the mixing circuit 12 from sneaking on another circuit through the semiconductor substrate 50.

As shown in FIG. 5, a guard ring 54 is formed in an adjacent area surrounding the N-well 52 close to the surface of the semiconductor substrate 50. The guard ring 54 is a part of the P-type semiconductor substrate 50 formed as an N-type area. As a PNP layer is formed by the guard ring 54 and the semiconductor substrate 50, it is possible to prevent the noise generated in the mixing circuit 12 from sneaking on another circuit through a portion close to the surface of the semiconductor substrate 50.

The present invention is not limited to the above embodiment, but various modified embodiments are possible within the gist thereof. For instance, the above embodiment described the FM receiver. However, the present invention is also applicable to various receivers such as an AM receiver and a data terminal device, transmitters or communication devices.

The above embodiment does not especially refer to a relationship between the frequency of the local oscillation signal and a carrier frequency of the modulated wave signal. However, the smaller a difference between these frequencies is, the lower the frequency of the medium-frequency signal outputted from the mixing circuit 12 becomes so that the influence of the 1/f noise becomes most significant. Therefore, it is possible to render the noise reduction most effective by applying the mixing circuit of the present invention to the receiver having such a setup.

According to the above-mentioned embodiment, all the components of the mixing circuit 12 are formed on the semiconductor substrate. However, it is also possible to have only some of them externally mounted.

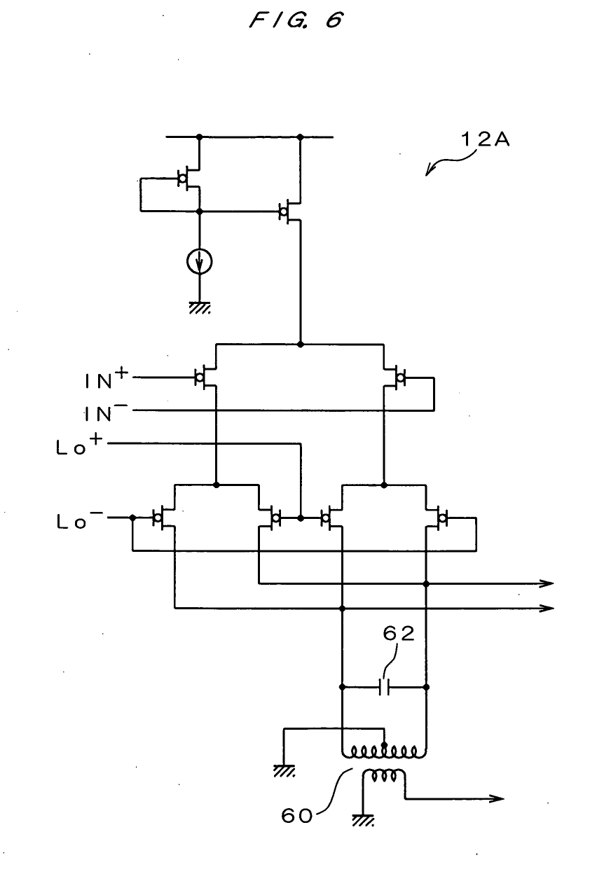

FIG. 6 is a sectional view showing another modified example of the mixing circuit. The mixing circuit 12A shown in FIG. 6 is the same as the mixing circuit 12 shown in FIG. 3 except that the load resistances 47 and 48 thereof are replaced by a transformer 60 and a capacitor 62. The semiconductor substrate has the components of the mixing circuit 12A other than the transformer 60 and capacitor 62 integrally formed thereon, and the transformer 60 and capacitor 62 as external components are connected via printed wiring and so on.

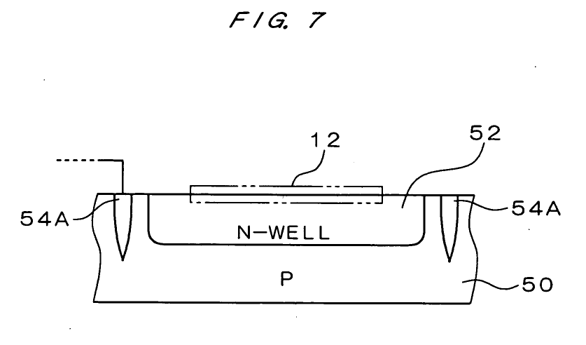

The example shown in FIG. 4 has the guard ring 54 formed close to the surface of the semiconductor substrate 50. It is possible as shown in FIG. 7, however, to use a guard ring 54A formed from the surface of the semiconductor substrate 50 down to the position deeper than the N-well 52 instead of the guard ring 54. Thus, in the case where the noise generated in the mixing circuit 12 molded on the N-well 52 sneaks on another circuit through the underside of the guard ring 54A (inside of the semiconductor substrate 50), it is possible to prevent a lower-frequency component from sneaking.

### INDUSTRIAL APPLICABILITY

As described above, according to the present invention, it is possible, by using the p-channel type FETs of which mobility is low as the transistors included in the frequency mixing circuit, to reduce the 1/f noise itself generated in the respective transistors so as to reduce the low-frequency noise generated in the entire frequency mixing circuit.

1. A frequency mixing circuit having components including transistors integrally molded with a semiconductor substrate by using CMOS process or MOS process, characterized in that said transistors are formed by using p-channel type FETs.

2. The frequency mixing circuit according to claim 1, characterized in that an N-well is formed on said semiconductor substrate, and said components are formed on the N-well.

3. The frequency mixing circuit according to claim 1, characterized in that said semiconductor substrate has a guard ring formed around the components thereon.

4. The frequency mixing circuit according to claim 2, characterized in that the guard ring is formed, around said components, from said semiconductor substrate's surface to a position deeper than said N-well.
